(19) United States
(12) Patent Application Publication
(10) Pub. No.: US 2006/0099380 A1
(43) Pub. Date: May 11, 2006

(54) Motor vehicle floor covering comprising a tufted velour carpet layer, and method for producing the same

(76) Inventors: Herbert Vollmert, Nettetal (DE); Ralph Bungenberg, Duesseldorf (DE); Gerhard Hoffe, Hess. Oldendorf (DE)

Correspondence Address: WILLIAM COLLARD;COLLARD & ROE, P.C., 1077 NORTHERN BOULEVARD, ROSLYN, NY, 11576, US

(21) Appl. No.: 10/516,896

(22) PCT Filed: May 13, 2003
(86) PCT No.: PCT/EP03/04979

§ 371 Date: Aug. 12, 2005

(30) Foreign Application Priority Data
Jun. 5, 2002 (DE) 102 25 072.3

(51) Int. Cl. B32B 3/02; B32B 33/00; D05C 17/02

(52) U.S. Cl. 428/92; 428/95; 428/88

(57) ABSTRACT

The invention relates to a floor covering for motor vehicles, comprising a tufted velour carpet layer. The floor covering has a tuft carrier carrying pile knots and provided with longitudinal rows of tufts, comprising zigzagged back-stitches, on the lower side thereof. In order to reduce the weight of one such motor vehicle carpeted floor system and to improve the acoustic efficiency, the tuft carrier comprises a plurality of perforations defining gaps between the pile knots, the perforations being produced by tufting needles without pile yarns. The inventive method is essentially characterised in that, in order to produce the velour carpet layer, a plurality of pile yarns are introduced into a tuft carrier according to a racking technique, by means of a plurality of tufting needles held in a needle holder, in such a way as to create longitudinal rows of tufts, comprising zigzagged back-stitches, on the lower side of the tuft carrier, a plurality of perforations defining gaps between the pile knots being produced in the tuft carrier by means of tufting needles without pile threads.

The invention relates to a floor covering for motor vehicles, with a tufted velour carpet layer comprising a tuft carrier which carries pile knots and is provided with longitudinal rows of tufts, comprising zigzagged back-stitches on the underside thereof. Furthermore, the invention relates to a method for producing a tufted velour carpet layer as part of a motor vehicle floor covering, in which method, by means of a plurality of tufting needles held in a needle holder, a plurality of pile yarn is introduced into a tuft carrier according to a racking technique in such a way as to create longitudinal rows of tufts, comprising zigzagged back-stitches, on the underside of the tuft carrier.

Generally, the top web of floor coverings in motor vehicles comprises a carpet, which can be a loop fabric, a velour carpet or a needleloom pile carpet, e.g. dilour. Floor coverings in motor vehicles are serving in particular also as sound insulation. A noticeable reduction in the interior noise level in the interior of the vehicle means a reduction in the impairment of the vehicle occupants. As a result of this, the driver is better able to perceive the traffic situations all round, and voice audibility in the passenger compartment is improved.

A great number of sound insulating floor coverings for passenger motor vehicles have already been developed. In many of these floor coverings the sound absorption performance is inadequate. While floor coverings for motor vehicles that provide satisfactory sound absorption performance exist, as a rule these have a relatively high mass per unit area which is disadvantageous in view of the efforts of reducing fuel consumption by reducing the vehicle's weight.

DE 199 60 945 A1 describes an acoustically effective floor covering for motor vehicles, which floor covering is said to be characterised by a particularly low mass per unit area. This known floor covering comprises a tufted velour carpet layer, a nonwoven support fabric, a bonding layer, a sintered polyethylene layer, a two-layered nonwoven fibre fabric comprising a nonwoven polyester fibre fabric and a nonwoven polypropylene fabric arranged underneath, as well as an underlying polyurethane foam. There is no heavy layer such as is often found in other sound-absorbing floor coverings.

It is the object of the present invention to create a textile floor covering for motor vehicles which is light in weight and provides improved acoustic effectiveness. Furthermore, a method for the production of such a floor covering is to be stated.

This object is met by the floor covering according to claim 1 and by the method according to claim 13 respectively.

The floor covering according to the invention is essentially characterised by a tufted velour carpet layer which has a tuft carrier carrying pile knots and has longitudinal rows of tufts, comprising zigzagged back-stitches, on the underside thereof, wherein the tuft carrier comprises a plurality of perforations defining gaps between the pile knots, said perforations having been produced by tufting needles without pile yarn.

Accordingly, the method according to the invention is essentially characterised in that, in order to produce a tufted velour carpet layer, a plurality of pile yarn is introduced into a tuft carrier according to a racking technique, by means of a plurality of tufting needles held in a needle holder, in such a way as to create longitudinal rows of tufts comprising zigzagged back-stitches, on the underside of the tuft carrier, a plurality of perforations defining gaps between the pile knots being produced in the tuft carrier by means of tufting needles without pile yarn.

The floor covering according to the invention comprises a tufted velour carpet layer with a considerably reduced weight, wherein the gaps between the pile knots in the carpet's pile layer as well as the perforations in the tuft carrier provide an acoustically effective air volume which improves the sound-absorbing effect of the floor covering and can take advantage of the lower structure of the sound absorber, respectively.

The pile knots and the gaps between the pile knots, respectively, can be arranged in such a way in the carpet layer that in parallel transverse rows of tufts a single perforation which defines a gap between the pile knots, in each case, alternates with two subsequent pile knots. To this effect, every third tufting needle of a tufting needle row is stuck without a pile yarn into the tuft carrier. As a result of this, the pile weight can be reduced by approximately one third.

Still greater weight savings can be achieved if according to a preferred embodiment of the invention each second needle of a row of tufting needles is stuck in an empty state in the tuft carrier. This results in parallel transverse rows of tufts in which in each instance a single pile knot is followed by a single perforation which defines a gap between the pile knots. In this embodiment the pile weight of the carpet layer is about half of the pile weight of conventional tufted carpets. The pile weight of carpet layers of conventional motor vehicle floor coverings is between 350 and 850 g/m². The reduction in the pile weight goes hand in hand with a reduction in the use of materials and thus with a reduction in costs.

According to an advantageous embodiment of the invention, consecutive back-stitches on the longitudinal rows of tufts encompass an angle of at least 100°, in particular of at least 110°, and preferably of approximately 1200 to 130°. In this embodiment, the spacing between consecutive parallel transverse rows of tufts is preferably approximately identical to the spacing of adjacent perforations in the respective transverse rows of tufts. Such an arrangement of tufts prevents the carpet pile layer from splitting open, i.e. it prevents exposure of the tuft carrier to the extent where said tuft carrier can be seen even if the velour carpet layer during deformation of the floor covering according to the invention is relatively severely deformed to match the contours of the vehicle floor on edges or the like. This results in particular in an improved structure or a more even appearance in the overall appearance of the velour carpet layer.

With the velour carpet layer designed according to the invention, despite a reduction in the pile weight, velours carpet layers with heavier pile weights can be imitated both from the point of view of appearance and haptic. Thus, by varying the length of the pile knots, the visual and haptical impression of a velour carpet with a pile weight of for example 800 g/m² can be conveyed, although the velour carpet layer constructed according to the invention in effect only has a pile weight of for example 400 g/m².

The floor covering according to the invention is in particular also suitable for lining the trunk of a motor vehicle. There up to now dilour carpets have frequently been used for covering the bottom and the wheel housings. However, this type of carpet is generally difficult to clean when compared to velour carpets.

Underneath the velour carpet layer, the floor covering according to the invention can preferably comprise a heavy layer and/or a soft layer made of foam material or nonwoven fibre fabric. Preferably, an acoustic spring-mass system is applied to the backing of the velours carpet layer, wherein said spring-mass system comprises at least one soft elastic layer as a spring, and at least one heavy layer as mass.

Further preferred and advantageous embodiments of the floor covering according to the invention are stated in the subordinate claims.

Below, the invention is explained in more detail with reference to a drawing which shows several embodiments. The Figures are diagrammatic presentation.

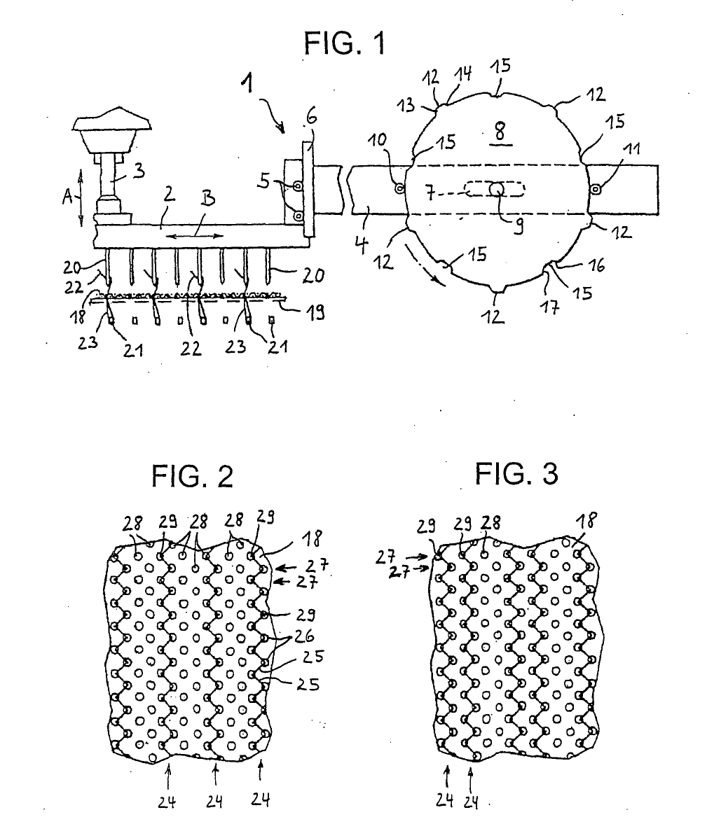

FIG. 1 shows a partially interrupted side view of a tufting machine operating with a slidable needle beam, in which tufting machine, for the sake of clarity, part of the sliding beam and a cam disc which causes needle racking (offset) are shown rotated by 90°;

FIG. 2 shows a simplified bottom view of a section of a velour carpet layer according to the invention, according to a first embodiment;

FIG. 3 shows a simplified bottom view of a section of a velour carpet layer according to the invention, according to a second embodiment;

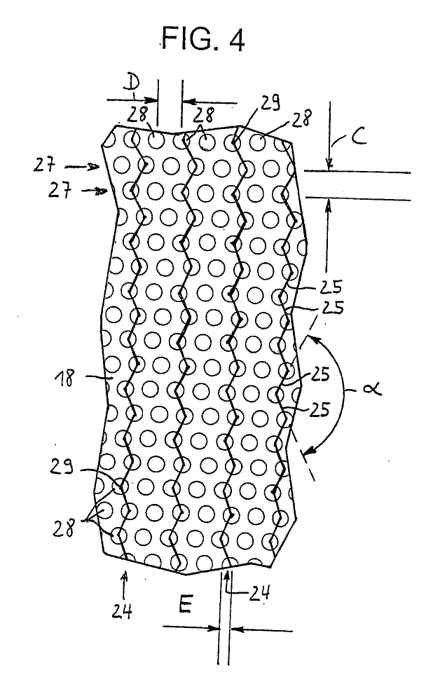

FIG. 4 shows a simplified bottom view of a section of a velour carpet layer according to the invention, according to a third embodiment;

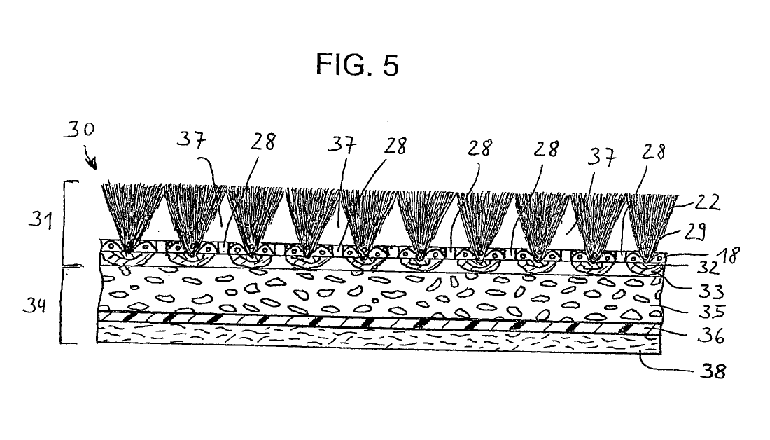

FIG. 5 shows a simplified cross-sectional view of a motor vehicle floor covering according to the invention; and

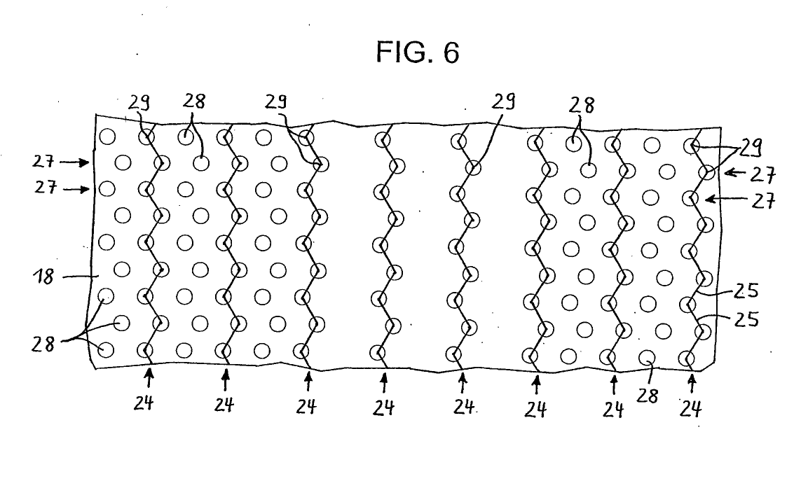

FIG. 6 shows a simplified bottom view of a section of a velour carpet layer according to the invention, according to a fourth embodiment.

FIG. 1 shows a tufting machine of a known type, as for example described in DE 34 09 574 C2. The tufting machine 1 comprises a beam-shaped needle holder 2 which is moved by a drive (not shown in detail) and an interacting piston rod 3 which moves to and fro so that said needle holder 2 moves up and down vertically and can be laterally displaced by a needle holder displacement device. This is indicated by the double arrows A and B.

The needle holder displacement device comprises a sliding beam 4 which can be displaced transversely; and at the end of which several guide rollers 5 are arranged so as to be spaced apart from each other, which guide rollers 5 provide a guide for a vertically arranged sliding beam carrier 6. The lower end section of the sliding beam carrier 6 is attached to the needle holder 2 so that it is moved up and down vertically with said needle holder 2 along the path determined by the guide rollers 5.

During its transverse movement, the sliding beam 4 imparts a lateral alternating movement to the carrier 6, which moves perpendicularly to and fro, and to the needle holder 2 while they move perpendicularly up and down. For longitudinal guidance, the sliding beam 4 comprises an elongated hole 7 which is penetrated with some play by a drive shaft 9 which drives a cam disc 8. The sliding beam 4 is moved transversely to and fro by two slide blocks 10, 11 which laterally protrude from the sliding beam 4. The slide blocks 10, 11 move on diametrically opposed rim sections of the circular cam disc 8. The circumference of the cam disc 8 comprises an odd number of elevations 12 which are distributed around the circumference of the cam disc 8 so as to be evenly spaced apart from each other. Each of the elevations 12 comprises a bevelled ascent flank 13 and a bevelled descent flank 14, wherein the outer ends of the flanks are connected by a flat or circular intermediate surface.

In each instance in the middle between the elevations 12, an equal number of depressions 15 are arranged, wherein the depressions 15 are in each case diametrically opposed to the elevations 12. Corresponding to the elevations 12, each depression 15 comprises a front flank 16 which inclines inward, and a rear flank 17 which inclines outward, wherein at the inside these flanks 16, 17 converge towards each other. The inner ends of these flanks are interconnected by a flat or circular intermediate surface. The depth of each depression 15 corresponds to the height of the associated elevation 12 which is located diametrically opposite it, so that each time an elevation 12 and an depression 15 contacts a slide block 10 or 11 it causes lateral displacement of the sliding beam 4. The height of the respective elevation 12 or the depth of the associated depression 15 determines the amount of transverse movement of the sliding beam 4 as well as of the needle holder 2.

The drive shaft 9 of the cam disc 8 is rotated in a time-controlled relationship to, or in synchronisation with, the up and down movement of the piston rod 3 or of the needle holder 2, respectively, so that in each cycle of the needle holder 2 moving up and down from the upper dead centre back to the upper dead centre, the cam disc 8 rotates by an angle which corresponds to the quotient from 360° and the sum of the elevations and depressions. In the embodiment shown in FIG. 1, the angle is thus 36°.

As is known per se, the tuft carrier 18, which can comprise a woven support fabric, a knitted support fabric, or a nonwoven support fabric, is advanced in a straight longitudinal path along a support surface 19 of the tufting machine 1 so that the subsequent transport sections of the tuft carrier 18, which extend across the tuft carrier, are brought beneath the needle holder 2, which moves to and fro, wherein said needle holder 2 extends transversely to the straight-line transport direction of the tuft carrier 18. The tuft carrier 18 is intermittently advanced by rollers (not shown) so that in sequence, in each cycle of the tufting machine, a new section of the tuft carrier 18 is brought below the needle holder 2.

As is the case in a conventional tufting machine, the needle holder 2 carries a plurality of parallel tufting needles 20 which point downwards and which are evenly spaced apart, wherein said tufting needles 20 are arranged in one or several cross sections. Each of the needles 20 is associated with a gripper 21 for gripping a pile thread loop. The grippers 21 are immovably held in transverse direction. In its normal, non-displaced, position, each tufting needle 20 is congruent with its associated gripper 21 or is brought to a position in which one side of the needle 20 is aligned so as to be flush with its associated gripper 21 before the needle 20 reaches its lower dead centre position. As can be seen from FIG. 1, only every second needle 20 has pile yarn 22 threaded through its eye which is located near the needle point. When the needle holder 2 is moved downward from its upper dead centre position, the points of the tufting needles 20 at the same time penetrate a transport section of the tuft carrier 18, wherein each of those tufting needles 20 which carry a pile yarn 22 inserts a thread loop 23 into the tuft carrier 18. If the needles 20 adequately penetrate the tuft carrier 18, within and below the tuft carrier 18 the thread loops 23 are formed which are gripped by the grippers 21 when the needle eyes approach their lower dead centre, wherein the grippers 21 catch the loops 23, in a way which is known per se, and hold them for an adequate period of time when the needles 20 are withdrawn from the tuft carrier 18. The grippers 21 are cut-pile grippers, each comprising a knife (not shown). The knife is used to cut open the thread loop so that a velour results.

Instead of the tufting machine according to FIG. 1 it is also possible, for producing a tufted velour carpet layer according to the invention, to use some other tufting machine which operates in racking technique.

FIG. 2 diagrammatically shows a section of the rear of a velour carpet layer according to the invention. It can be seen that due to the racking technique, on the underside of the tuft carrier 18, longitudinal rows of tufts 24 with zigzagged back-stitches 25 are generated. The back-stitches 25 run diagonally in one direction and then diagonally in the other direction between successive holes 26 (perforations) produced by the tufting needles 20 in the tuft carrier 18. In each longitudinal row 24 of tufts in the tuft carrier 18 the tufts are thus mutually offset and arranged in parallel transverse rows 27 (transverse rows of tufts).

The figure shows that the tuft carrier 18 comprises a plurality of perforations 28 which define gaps between the pile knots, which gaps were produced by tufting needles without pile yarn. In the embodiment shown in FIG. 2, in the parallel transverse rows 27 of tufts, each pile knot 29 alternates with a perforation 28 that defines a gap between the pile knots. In this embodiment, the gap between two adjacent transverse rows 27 of tufts approximately corresponds to the amount by which the tufts are mutually offset in the longitudinal rows 24 of tufts. In the embodiment shown, this amount of offset, for example, corresponds to approximately half of the spacing of the perforations 28 of a transverse row 27 of tufts, which spacing is specified by the spacing of adjacent tufting needles.

FIG. 3 shows a bottom view of a second embodiment of a velour carpet layer according to the invention. This carpet layer was also produced with a tufting machine according to FIG. 1. In this embodiment every third tufting needle 20 of the needle holder 2 remained empty so that in parallel transverse rows 27 of tufts every two pile knots 29 alternate with a single perforation 28 which defines a gap between the pile knots. Apart from this, further variations are possible concerning the number and distribution of longitudinal rows 24 of tufts and empty longitudinal rows of perforations, i.e. rows of perforations without pile yarn.

FIG. 4 shows a bottom view of a third embodiment of a velour carpet layer according to the invention. As is the case in the embodiment according to FIG. 2, in this embodiment in parallel transverse rows 27 of tufts, each pile knot 29 alternates with a perforation 28 that defines a gap between the pile knots. This embodiment differs from that shown in FIG. 2 in that the spacing C between two adjacent transverse rows 27 of tufts approximately corresponds to the needle spacing, and to spacing D, between two adjacent perforations 28 in the transverse row 27 of tufts, respectively. The amount E by which the tufts in the longitudinal rows 24 of tufts are mutually offset is clearly less than the spacing C between two adjacent transverse rows of tufts. The amount of offset E is selected by a corresponding design of the elevations 12 and the depressions 15 of the cam disc 8 shown in FIG. 1 such that successive back-stitches 25 of the respective longitudinal row of tufts encompass an angle α of approximately 130°.

FIG. 5 shows a simplified cross-sectional view of a section of a motor vehicle floor covering 30 according to the invention. The floor covering 30 comprises a tufted velour carpet layer 31 according to one of the embodiments shown in FIGS. 2 and 4. Reference number 18 designates a tuft carrier into which the pile yarn 22 and pile knots 29, respectively, are drawn. The tuft carrier 18 comprises a nonwoven fibre fabric, for example a spunbonded polyester material. The figure shows that the tuft carrier 18 comprises a plurality of perforations 28 defining gaps 37 between the pile knots, which perforations 28 were produced by tufting needles without pile yarn. The gaps 37 between the pile knots increase the acoustically effective air volume in the velour carpet layer.

For bonding (strengthening) the pile knots 29, on the underside of the tuft carrier 18 a first adhesive 32 is applied which during application is essentially only deposited on the pile knots 29 while essentially leaving free the perforations 28 that were produced by tufting needles without pile yarn. For bonding a subsequent acoustically effective layer 34, a pulverised adhesive 33 is sintered onto the pile knot binding structure, which adhesive again essentially only deposits in the region of the pile knots 29 thus leaving the perforations 28 free. In this embodiment, the acoustically active layer 34 comprises several layers. It is constructed according to the acoustic spring-mass principle and comprises an elastic soft layer 35 which serves as a spring, and a heavy layer 36 which serves as mass. The soft layer 35 can for example consist of an open-cell PUR foam, while the heavy layer 36 can for example consist of a caoutchouc (e.g. EPDM) or a thermoplastic elastomer. In the embodiment shown, on the underside of the heavy layer 36 a further soft layer 38 in the form of a nonwoven fibre fabric is arranged in addition.

The velour carpet layer 31 of this floor covering comprises a pile knot mass per unit area which ranges from 200 to 250 g/m². In relation to its entire surface, the velour carpet layer comprises an essentially homogeneous pile knot density. The tuft carrier 18 should comprise a maximum of 175,000 pile knots per m².

It is possible in the floor covering according to the invention, from a visual and tactile point of view, to imitate a greater use of pile, although a reduction in the pile weight has actually been achieved. To this effect the length of the pile knots can be varied, namely to lengths above 6 mm, or the stitch density can be varied up to 70 stitches for every 10 cm (in relation to the direction of the longitudinal rows of tufts). While an extension of the pile knots results in a certain increase of the pile mass per unit area, the actual pile mass is significantly lower than the pile mass which the velour carpet layer conveys with regard to its visual appearance and haptical impression. Thus, with a velour carpet layer constructed according to the invention, which carpet layer has a pile weight of for example 400 g/m², a velour carpet layer with a pile weight of for example approximately 800 g/m² can be imitated.

FIG. 6 diagrammatically shows a bottom view of a fourth embodiment of a velour carpet layer according to the invention. At the underside of the tuft carrier 18 again longitudinal rows 24 of tufts with zigzagged back-stitches 25 are formed due to the racking technique. The pile knots 29 are mutually offset in each longitudinal row 24 of tufts and are arranged in parallel transverse rows 27. As far as the arrangement of the perforations is concerned, the transverse rows 27 of tufts, which rows extend parallel in relation to each other, comprise different regions and sections, respectively.

The figure shows that there is one region in which each pile knot 29 alternates with a perforation 28 that defines a gap between the pile knots. Furthermore, each transverse row of tufts comprises a region in which several pile knots 29 follow without there being any perforations in between. In contrast to the embodiments shown in FIGS. 2 and 4, the velour carpet layer according to FIG. 6 is made with the use of tufting needles without pile yarn as well as by targeted leaving-out of tufting needles without pile yarn. Such a production method makes it possible on the one hand by selectively leaving out tufting needles without pile yarn to create relatively high strength in the carpet in some areas, while on the other hand by means of tufting needles without pile yarn to provide acoustically effective perforations 28 (holes) only in areas where this is expedient. As shown in FIG. 6, the spacing between the tufts or between the perforations 28 in the transverse rows 27 of tufts can vary.

Implementation of the invention is not limited to the embodiments described above. Instead, further variants are imaginable which even in basically different design use the inventive idea stated in the enclosed claims. Thus it is, for example, possible to combine the features of the embodiments shown in FIGS. 2, 3, 4 and 6. In particular it is possible to design the velour carpet layer such that in parallel transverse rows of tufts at least one region is formed in which three or more pile knots 29 are placed in sequence, and at least one region is formed in which each individual perforation 28 defining a gap between the pile knots is followed by two pile knots 29.

1. A floor covering for motor vehicles, with a tufted velour carpet layer (31), comprising a tuft carrier (18) which carries pile knots and is provided with longitudinal rows of tufts (24), comprising zigzagged back-stitches (25), on the underside thereof, wherein the tuft carrier (18) comprises a plurality of perforations (28),
wherein
the tuft carrier (18) comprises a plurality of perforations (28) defining gaps (37) between the pile knots, said perforations being produced by tufting needles without pile yarn so that between longitudinal rows (24) of tufts, comprising zigzagged back-stitches (25), longitudinal perforation rows are formed that have been made by tufting needles without pile yarn, wherein for binding the pile knots (29) to the underside of the tuft carrier (18) an adhesive material (32) has been applied, which adhesive material (32) essentially leaves free the perforations (28) that have been formed by the tufting needles without pile yarn.

2. The floor covering according to claim 1,
wherein
in parallel transverse rows (27) of tufts a perforation (28) which defines a gap (37) between the pile knots in each case alternates with a pile knot (29).

3. The floor covering according to claim 1,
wherein
in parallel transverse rows (27) of tufts a single perforation (28) which defines a gap (37) between the pile knots in each case alternates with two pile knots (29).

4. The floor covering according to claim 1
wherein
in relation to its entire surface, the velour carpet layer (31) comprises an essentially homogeneous pile knot density.

5. The floor covering according to claim 1,
wherein
in parallel transverse rows (27) of tufts at least one region is formed in which several pile knots (29) are placed in sequence, and at least one region is formed in which each individual perforation (28) defining a gap (37) between the pile knots is followed by one pile knot (29).

6. The floor covering according to claim 1,
wherein
in parallel transverse rows (27) of tufts at least one region is formed in which three or more pile knots (29) are placed in sequence, and at least one region is formed in which each individual perforation (28) defining a gap (37) between the pile knots is followed by two pile knots (29).

7. The floor covering according to claim 1
wherein
consecutive back-stitches (25) on the respective longitudinal row (24) of tufts encompass an angle (α) of at least 100°.

8. The floor covering according to claim 1
wherein
consecutive back-stitches (25) on the respective longitudinal row (24) of tufts encompass an angle (α) of at least 110°.

9. The floor covering according to claim 1
wherein
the spacing (C) between consecutive parallel transverse rows of tufts (27) is approximately identical to the spacing (D) of adjacent perforations (28) in the respective transverse rows (27) of tufts.

10. The floor covering according to claim 1
wherein
the height or length of the pile knots (29) is at least 7 mm.

11. The floor covering according to claim 1
wherein
the pile knot mass per unit area of the velour carpet layer (31) ranges from 200 to 250 g/m².

12. The floor covering according to claim 1
wherein
the tuft carrier (18) comprise a maximum of 175,000 pile knots per m².

13. A method for producing a tufted velour carpet layer (31) as part of a motor vehicle floor covering (30), in which method, by means of a plurality of tufting needles (20) held in a needle holder (2), a plurality of pile yarn (22) is introduced into a tuft carrier (18) according to a racking technique in such a way as to create longitudinal rows (24) of tufts, comprising zigzagged back-stitches (25), on the underside of the tuft carrier (18),
wherein
a plurality of perforations (28) defining gaps (37) between the pile knots are produced in the tuft carrier (18) by means of tufting needles (20) without pile yarn.

14. The method according to claim 13,
wherein
the perforations (28) defining the gaps (37) between the pile knots are introduced such that in parallel transverse rows (27) of tufts a perforation (28) which defines a gap (37) between the pile knots in each case alternates with a pile knot (29).

15. The method according to claim 13,
wherein
the perforations (28) defining the gaps (37) between the pile knots are introduced such that in parallel transverse rows (27) of tufts a single perforation (28) which defines a gap (37) between the pile knots in each case alternates with two pile knots (29).

16. The method according to claim 13,
wherein
the advance movement of the tuft carrier (18) and the sliding movement of the tufting needles (20) are matched such that the spacing (C) between subsequent parallel transverse rows (27) of tufts is larger than the amount (E) by which the tufting needles (20) in the racking technique are offset from one transverse row (27) of tufts to another transverse row (27) of tufts.

17. The method according to claim 13,
wherein
the spacing (C) between two adjacent parallel transverse rows (27) of tufts approximately corresponds to the spacing (D) between adjacent tufting needles.

18. The method according to claim 13,
wherein
in relation to its entire surface, the velour carpet layer (31) is produced such that it comprises an essentially homogeneous pile knot density.
